(19) United States
(12) Patent Application Publication
(10) Pub. No.: US 2025/0056470 A1
(43) Pub. Date: Feb. 13, 2025

(54) POSITIONING MEASUREMENT REQUEST INCLUDING NUMBER OF PATHS

(71) Applicant: Telefonaktiebolaget LM Ericsson (publ), Stockholm (SE)

(72) Inventors: Florent Munier, Västra Frölunda (SE); Mohammed Yazid Lyazidi, London (GB)

(21) Appl. No.: 18/719,322

(22) PCT Filed: Dec. 20, 2022
(86) PCT No.: PCT/IB2022/062539

§ 371 Date: Jun. 13, 2024

Related U.S. Application Data
(60) Provisional application No. 63/291,819, filed on Dec. 20, 2021.

(51) Int. Cl. H04W 64/00

(52) U.S. Cl. CPC H04W 64/00

(57) ABSTRACT

Systems and methods are disclosed for sending, receiving, and processing a positioning measurement request including a number of paths in a cellular communications system. In one embodiment, a method performed by a base station for exchange of messages related to a location of a User Equipment (UE) with a Location Management Function (LMF) comprises receiving a measurement request from the LMF, the measurement request comprising information that indicates a desired number of reported path measurements between the base station and the UE. The method further comprises performing measurements on paths between the base station and the UE, generating a measurement response message comprising results of the measurements for the desired number of reported path measurements, and transmitting the measurement response message to the LMF.

### RELATED APPLICATIONS

This application claims the benefit of provisional patent application Ser. No. 63/291,819, filed Dec. 20, 2021, the disclosure of which is hereby incorporated herein by reference in its entirety.

### TECHNICAL FIELD

The present disclosure relates to a positioning in a cellular communications system.

### BACKGROUND

Positioning in 3^{rd} Generation Partnership Project (3GPP) New Radio (NR) is supported by the architecture shown in FIG. 1. A Location Management Function (LMF) is the location node in NR. There are also interactions between the LMF and the New Radio Base Station (gNB) via the New Radio Positioning Protocol Annex (NRPPa) protocol. The interactions between the gNB and the User Equipment (UE) are supported via the Radio Resource Control (RRC) protocol, while the LMF interfaces with the UE via the Long Term Evolution (LTE) Positioning Protocol (LPP). LPP is common to both NR and LTE.

FIG. 2 illustrates a split gNB architecture with Transmission-Reception-Points (TRPs). As illustrated in FIG. 2, in the split gNB architecture, the gNB may include a gNB-Central Unit (gNB-CU) and one or more gNB-Distributed Units (gNB-DUs). In the split gNB architecture with F1 interface, the gNB-CU terminates NR Positioning Protocol A (NRPPa). TRPs are located in the gNB-DU. A TRP is defined by its TRP Identity (ID) and Cell ID, where Cell ID is optional. There can be gNB-DU with positioning functionality only.

In NR Release 16, a number of positioning features were specified including reference signals, measurements, and positioning methods. In particular, the following methods are newly introduced in NR: (a) Multicell Round Trip Time (RTT): the LMF collects RTT measurement as the basis for multilateration; (b) downlink (DL) Angle of Departure (AoD) and uplink (UL) Angle of Arrival (AoA), where multilateration is done using angle and power (Reference Signal Received Power (RSRP)) measurements.

In NR Release 16, the following gNB measurements are specified: (a) Uplink-Relative Time of Arrival (UL-RTOA), useful for Uplink-Time Difference of Arrival (UL-TDOA) positioning; (b) gNB Reception-Transmission (Rx-Tx) time difference, useful for multi-cell RTT measurements; (c) UL Sounding Reference Signal (SRS)-RSRP; and (d) Azimuth-of-Arrival and Zenith-of-Arrival.

### Sequence of Procedure for UL-AoA Positioning

FIG. 3 reproduces “Figure 8.14.3.4-1” in 3GPP Technical Specification (TS) 38.305 V16.6.0 (2021-09). FIG. 3 shows the messaging among the LMF, the gNBs, and the UE to perform the UL-AoA procedure. An explanation of FIG. 3 is described in is the following excerpt from section “8.14.3.4 Sequence of Procedure for UL-AoA positioning” from 3GPP TS 38.305:

### *****Start of Excerpt from 3GPP TS 38.305 V16.6.0*****

0. The LMF may use the procedure in Figure 8.14.3.2.1-2 to obtain the TRP information required for UL-AoA positioning.
1. The LMF may request the positioning capabilities of the target device using the LPP Capability Transfer procedure as described in clause 8.14.3.1.
2. The LMF sends a NRPPa POSITIONING INFORMATION REQUEST message to the serving gNB to request UL-SRS configuration information for the target device as described in Figure 8.14.3.2.1-1.
3. The serving gNB determines the resources available for UL-SRS and configures the target device with the UL-SRS resource sets at step 3a.
4. The serving gNB provides the UL-SRS configuration information to the LMF in a NRPPa POSITIONING INFORMATION RESPONSE message.
5. In the case of semi-persistent or aperiodic SRS, the LMF may request activation of UE SRS transmission by sending the NRPPa Positioning Activation Request message to the serving gNB of the target device as described in clause 8.14.3.3a. The gNB then activates the UL-SRS transmission and sends the NRPPa Positioning Activation Response message. The target device begins the UL-SRS transmission according to the time domain behavior of UL-SRS resource configuration.
6. The LMF provides the UL-SRS configuration to the selected gNBs in a NRPPa MEASUREMENT REQUEST message as described in clause 8.14.3.3. The message includes all information required to enable the gNBs/TRPs to perform the UL measurements.
7. Each gNB configured at step 6 measures the UL-SRS transmissions from the target device.
8. Each gNB reports the UL-SRS measurements to the LMF in a NRPPa Measurement Response message as described in clause 8.14.3.3.
9. The LMF sends a NRPPa POSITIONING DEACTIVATION message to the serving gNB as described in clause 8.14.3.3a.

### *****End of Excerpt from 3GPP TS 38.305 V16.6.0*****

In Release 17, it was agreed, among other items, to specify enhancements for the DL AoD and UL AoA methods. In UL AoA based methods, the LMF will indicate, to the serving gNB, the need to direct the UE to transmit SRS signals for uplink positioning. The UE transmits the SRS towards the gNB, and the gNB measures the AoA of the SRS.

For example, the following agreement has been made in 3GPP (see 3GPP TSG-RAN3 Meeting #112-e, 17-28 May 2021, R3-212691, Agenda Item: 19.2.1):
Reporting to LMF of M>1 UL-AOA (AoA/ZoA) measurement values associated with the first arrival path and corresponding to the same timestamp is supported.

The following has also been agreed (see R1-2110573):
Reporting multiple UL-AoA values per SRS resource for the additional path is supported for at least UL TDOA and multi-RTT.
FFS: maximum number of UL-AoA values per additional path.

The NRPPa protocol provides some basic reporting means of UL AoA explained in section 9.2.38 (“UL Angle of Arrival”) of 3GPP TS 38.455 V16.5.0 (2021-21), where the gNB can report some information elements associated to UL AoA of a specific UE with respect to a specific TRP or Next Generation Radio Access Network (NG-RAN) access point position. FIG. 4 shows the table in section 9.2.38 of 3GPP TS 38.455 V16.5.0 (2021-21), which describes the information elements containing UL AoA measurements.

### SUMMARY

Systems and methods are disclosed for sending, receiving, and processing a positioning measurement request including a number of paths in a cellular communications system. In one embodiment, a method performed by a base station for exchange of messages related to a location of a User Equipment (UE) with a Location Management Function (LMF) comprises receiving a measurement request from the LMF, the measurement request comprising information that indicates a desired number of reported path measurements between the base station and the UE. The method further comprises performing measurements on paths between the base station and the UE, generating a measurement response message comprising results of the measurements for the desired number of reported path measurements, and transmitting the measurement response message to the LMF. In this manner, usage of interfaces in the network can be improved since only a desired number of paths can be reported between the LMF and base station.

In one embodiment, the information that indicates the desired number of reported paths with measurements is comprised in an information element within the measurement request.

In one embodiment, the desired number of reported path measurements is indicated for a particular measurement type.

In one embodiment, the desired number of reported path measurements comprises at least one of (a) a desired number of reported additional paths and (b) a desired number of Uplink Angle of Arrival (UL-AoA) values per additional path.

In one embodiment, the measurements comprise one or more of (a) UL-AoA measurements, (b) Uplink Related Time of Arrival (UL-RTOA) measurements, and (c) Reception-Transmission (Rx-Tx) measurements between the base station and the UE.

In one embodiment, the base station comprises a distributed unit and a central unit, wherein receiving the measurement request message comprises receiving the measurement request message from the LMF at the central unit, wherein the central unit sends the measurement request message to the distributed unit.

Corresponding embodiments of a base station are also disclosed. In one embodiment, a base station is adapted to receive a measurement request from the LMF, the measurement request comprising information that indicates a desired number of reported path measurements between the base station and the UE. The base station is further adapted to perform measurements on paths between the base station and the UE, generate a measurement response message comprising results of the measurements for the desired number of reported path measurements, and transmit the measurement response message to the LMF.

In one embodiment, a base station comprises processing circuitry configured to cause the base station to receive a measurement request from the LMF, the measurement request comprising information that indicates a desired number of reported path measurements between the base station and the UE. The processing circuitry is further configured to cause the base station to perform measurements on paths between the base station and the UE, generate a measurement response message comprising results of the measurements for the desired number of reported path measurements, and transmit the measurement response message to the LMF.

Embodiments of a method performed by a LMF are also disclosed. In one embodiment, a method performed by a LMF for exchange of messages related to a location of a UE with a base station comprises transmitting a measurement request to the base station, the measurement request comprising information that indicates a desired number of reported path measurements between the base station and the UE. The method further comprises receiving a measurement response message comprising measurement results for the desired number of reported path measurements from the base station.

In one embodiment, the information that indicates the desired number of reported paths with measurements is comprised in an information element within the measurement request.

In one embodiment, the desired number of reported path measurements is indicated for a particular measurement type.

In one embodiment, the desired number of reported path measurements comprises at least one of (a) a desired number of reported additional paths and (b) a desired number of UL-AoA values per additional path.

In one embodiment, the reported path measurements comprise one or more of (a) UL-AoA measurements, (b) UL-RTOA measurements, and (c) Rx-Tx measurements between the base station and the UE.

In one embodiment, the base station comprises a distributed unit and a central unit, wherein transmitting the measurement request message comprises transmitting the measurement request message from the LMF to the central unit.

Corresponding embodiments of an LMF are also disclosed. In one embodiment, a LMF is adapted to transmit a measurement request to the base station, the measurement request comprising information that indicates a desired number of reported path measurements between the base station and the UE. The LMF is further adapted to receive a measurement response message comprising measurement results for the desired number of reported path measurements from the base station.

In one embodiment, a network node for implementing an LMF comprises processing circuitry configured to cause the network node to transmit a measurement request to the base station, the measurement request comprising information that indicates a desired number of reported path measurements between the base station and the UE. The processing circuitry is further configured to cause the network node to receive a measurement response message comprising measurement results for the desired number of reported path measurements from the base station.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the 3^{rd} Generation Partnership Project (3GPP) New Radio (NR) architecture supporting positioning;

FIG. 2 illustrates a split NR base station (gNB) architecture with Transmission-Reception-Points (TRPs);

FIG. 3 is a reproduction of “FIG. 8.14.3.4-1” in 3GPP Technical Specification (TS) 38.305 V16.6.0 (2021-09);

FIG. 4 shows the table in section 9.2.38 of 3GPP TS 38.455 V16.5.0 (2021-21);

FIG. 5 illustrates one example of illustrates one example of a cellular communications system in which embodiments of the present disclosure may be implemented;

FIG. 6 is a version of FIG. 4 that is modified in accordance with one example embodiment of the present disclosure;

FIG. 7 illustrates an information element in accordance with one example embodiment of the present disclosure;

FIG. 8 illustrates an information element in accordance with one example embodiment of the present disclosure;

FIG. 9 illustrates a procedure in accordance with one embodiment of the present disclosure;

FIGS. 10, 11, and 12 are schematic block diagrams of example embodiments of a radio access node; and

FIGS. 13, 14, and 15 are schematic block diagrams of a network node that implements a Location Management Function (LMF) in accordance with embodiments of the present disclosure.

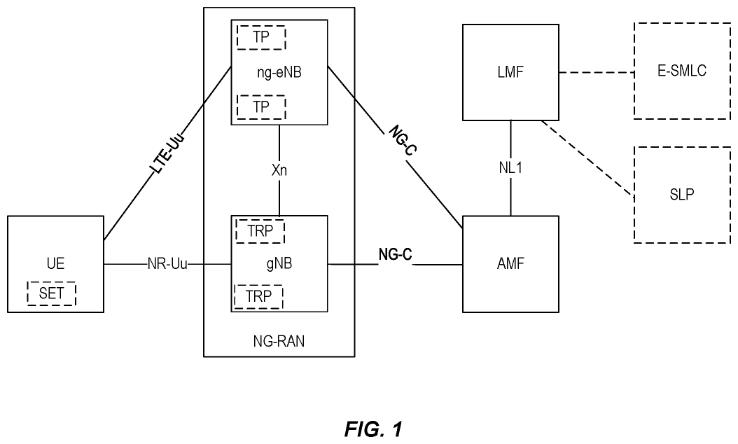

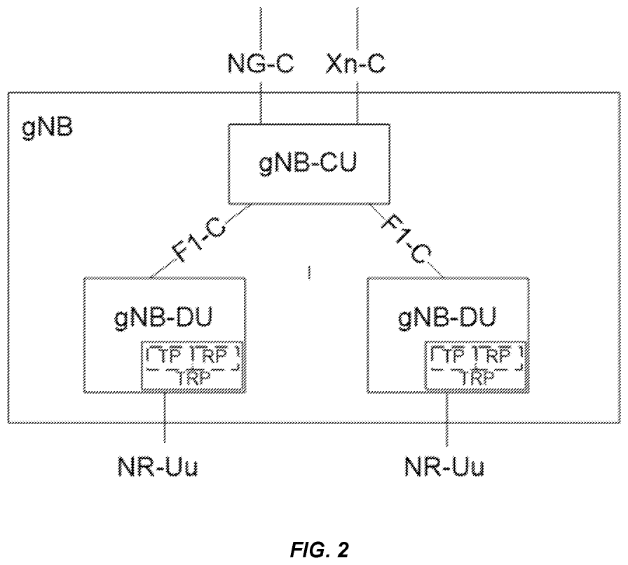

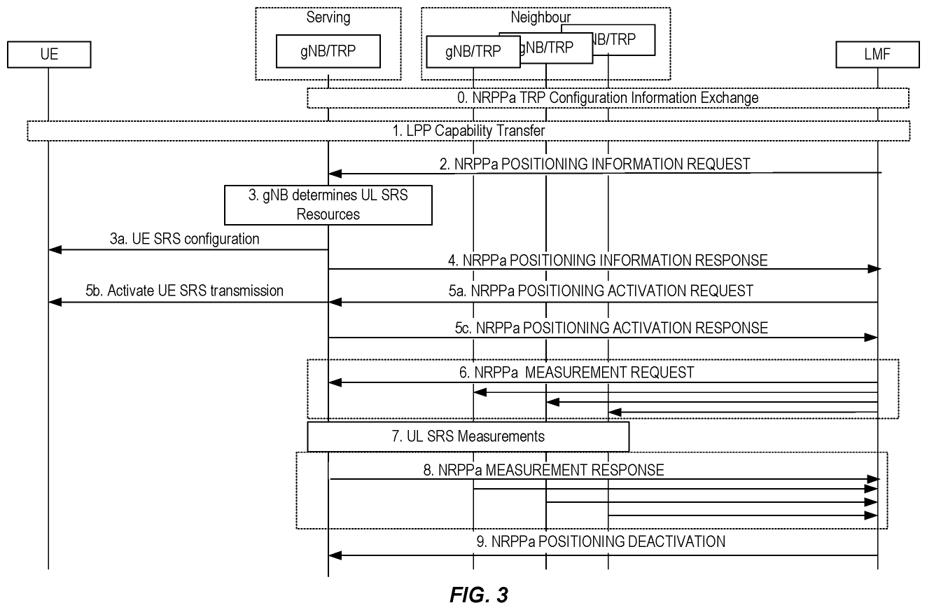

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

For the definition of a TRP provided by 3GPP, see 3GPP TS 38.305, section 3.1.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). NR Positioning Protocol Annex A (NRPPa) allows the Location Management Function (LMF) to request measurements from the gNB using the NRPPa “measurement request” message as described in section 8.14.3.3 of 3GPP 38.455 V16.5.0 (2021-21). The measurement request message includes all information required to enable the gNBs/TRPs to perform the uplink (UL) measurements. The measurement request message is described in section 9.1.4.1 (“MEASUREMENT REQUEST”) of 3GPP 38.455 V16.5.0 (2021-21) as follow:

### *****Start of Excerpt from Section 9.1.4.1 of TS 38.455*****

### 9.1.4.1 Measurement Request

This message is sent by the LMF to request the NG-RAN node to configure a positioning measurement.
Direction: LMF→NG-RAN node.

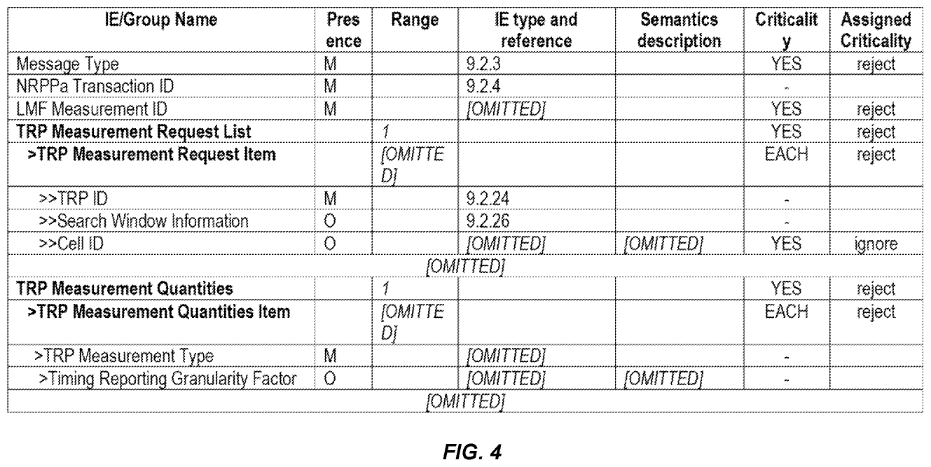

### Table in this Position is Reproduced in FIG. 4 of the Present Application

### *****End Excerpt from Section 9.1.4.1 of TS 38.455*****

The measurement request message only specifies the type of measurement to be reported in the TRP Measurement Type Information Element (IE). For multipath measurements such as UL Relative Time of Arrival (RTOA), the measurement request is not specific and leaves to the gNB to decide how many paths should be reported, typically, in a best effort way. The reasoning is that the number of detectable paths varies with the channel conditions and, therefore, the number of reported paths cannot be predicted or guaranteed.

This can, however, lead to an over-reporting from the gNB. In Release 17, the gNB will be allowed to report up to eight (8) paths per UL RTOA or gNB Receive-Transmit (RxTx) report. Moreover, each path can be reported together with up to eight (8) different Angle of Arrival (AoA) values. Recently, in 3GPP RAN1, support of hybrid positioning methods encompassing AoA with UL-RTOA and gNB-Rx-Tx measurements was agreed. For example, in R3-2110573, it has agreed, “Reporting multiple UL-AoA values per additional path is supported for at least UL TDOA and multi-RTT.” However, the maximum number of UL-AoA values per additional path is subject to further future study (FFS). Also, in R3-2110573, it has agreed, “For hybrid positioning methods where UL TDOA and multi-RTT are used in addition to UL AoA, support reporting of up to M=8 UL-AoA values per additional path.”

There will be up to eight (8) UL-AoA values for the additional path to be reported from the gNB to the LMF per additional path, leading to up to sixty-four (64) values of path reporting. Clearly, the gNB, the LMF, and NRPPa interface would benefit from knowledge that only a certain number of paths are needed by the LMF positioning algorithm. For example, for some methods, the LMF may choose to only use the earliest path without using additional paths.

Certain aspects of the present disclosure and their embodiments may provide solutions to the aforementioned or other challenges. The present disclosure proposes to add to the measurement request the possibility for the LMF to specify the desired number of paths to be reported by the gNB (or the gNB-DU). The gNB (or the gNB-DU) can decide to override the request and decide to report more or less paths in the report, but will at least be informed of the objective of the LMF.

In some embodiments of the present disclosure, a positioning server (e.g., the LMF) is allowed to request a specific number of paths in the measurement request towards the RAN node. In some embodiments of the present disclosure, the gNB receives a measurement request with an indication of the desired number of paths reported for a measurement. Based on the request, the gNB may elect to report the desired number of paths or another number of paths. In case of F1 split architecture, the gNB-CU signals the requested number of paths to the gNB-DU.

Certain embodiments may provide one or more of the following technical advantage(s). Usage of the NRPPa and F1AP interfaces is improved since only the required number of paths can be reported between the LMF and the gNB (or gNB-DU).

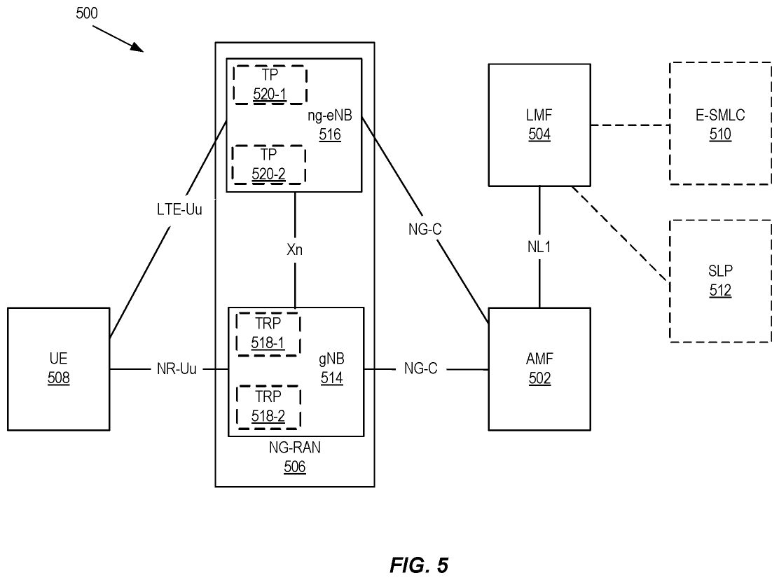

FIG. 5 illustrates one example of illustrates one example of a cellular communications system 500 in which embodiments of the present disclosure may be implemented. As illustrated, the system 500 includes an AMF 502, an LMF 504, a NG-RAN 506, a UE 508, and optionally an Enhanced Serving Mobile Location Center (E-SMLC) 510 and/or a SUPL (Secure User Plane Location) Location Platform (SLP) 512. The NG-RAN 506 includes, in this example, a NR base station (gNB) 514 and a next generation eNB (ng-eNB) (e.g., LTE RAN nodes connected to the 5GC) 516. The gNB 514 may include TRPs 518-1 and 518-2, and the gNB 516 may include Transmission Points (TPs) 520-1 and 520-2.

As illustrated in FIG. 5, the AMF 502 (included in the core network) is connected with the LMF 504 via the NL1 interface. The LMF 504 is an entity that is central in the 5G positioning architecture. The LMF 504 receives measurements and assistance information from the NG-RAN 506 and the UE 508, via the AMF 502, over the NL1 interface to compute the position of the UE 508. Due to the new next generation interface between the NG-RAN 506 and the AMF 502, a new NR Positioning Protocol Annex (NRPPa) protocol was introduced to carry the positioning information between the NG-RAN 506 and the LMF 504 over the next generation control plane interface (NG-C). These additions in the 5G architecture provide the framework for positioning in 5G. The LMF 504 configures the UE 508 using the LTE positioning protocol (LPP) via the AMF 502. The NG RAN 506 configures the UE 508 using the Radio Resource Control (RRC) protocol.

Optionally, the LMF 504 may be connected with the E-SMLC 510 and/or the SLP 512. The LMF 504 may have a signaling connection to the E-SMLC 510 which may enable the LMF 504 to access information from Evolved-Universal Mobile Telecommunications System (UMTS) Terrestrial Radio Access Network (E-UTRAN). The LMF 504 may have a signaling connection to the SLP 512, which is the SUPL entity responsible for positioning over the user plane.

In one embodiment, the NRPPa message (“MEASUREMENT REQUEST”) is sent by the LMF 504 to request the gNB 514 (included in the NG-RAN 506) to configure a positioning measurement. The NRPPa message (“MEASUREMENT REQUEST”) includes the desired number of reported path measurements (between the gNB 514 and the UE 504) to be included in the measurement report.

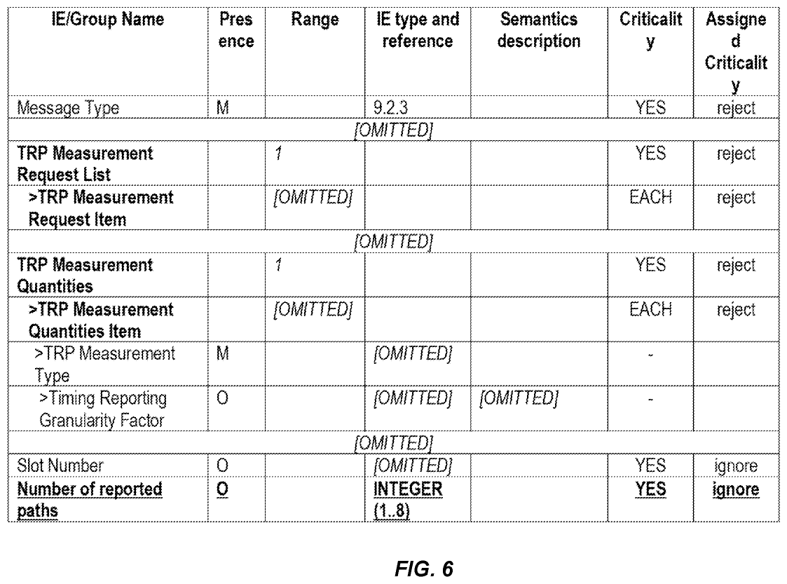

In another embodiment, the desired number of reported path measurements can be included in a different level in the measurement request. For example, the desired number of reported path measurements could be specified for all the measurements included in the request with an inclusion in the request. That is, the table in section 9.1.4.1 (“MEASUREMENT REQUEST”) of 3GPP 38.455 V16.5.0 (2021-21), reproduced in FIG. 4, is modified as illustrated in FIG. 6, in one embodiment. In the table of FIG. 6, the newly added IE (“Number of reported paths”) is marked with underlined and bold text.

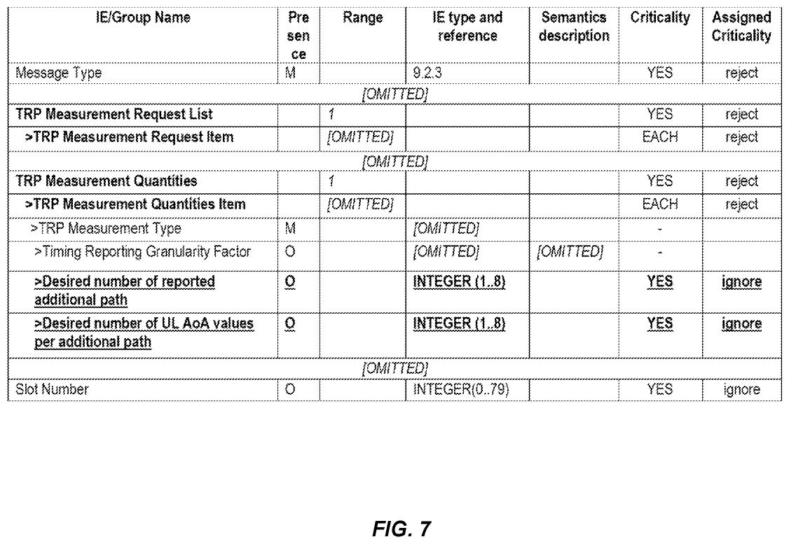

In another embodiment, the desired number of paths can be included for a particular measurement type, for example, as a part of “TRPMeasurementQuantitiesList” IE where measurements can already be configured with a specific granularity. This embodiment is shown (marked with underlined and bold text) in the table of FIG. 7 where the number of UL-AoA values to be reported per additional path, and additional path are indicated in the request message. That is, two new elements (“Desired number of reported additional path” and “Desired number of UL AoA values per additional path”) are added to the “TRP Measurement Quantities item” IE of the message request message.

In 3GPP TS 38.473 V16.7.0, 2021-10 (“F1 application protocol (F1AP)”), the positioning message mirroring the NRPPa message described above is enhanced to support signaling the desired number of request additional paths for the positioning session, or number of additional path and UL AoA values per additional path for a specific measurement. Section 9.2.12.3 of 3GPP TS 38.473 V16.7.0, 2021-10 describes the positioning measurement request message that is “send by the gNB-CU to request the gNB-DU to configure a positioning measurement” and the direction of the positioning measurement request message is from the gNB-CU to the gNB-DU. According to some embodiments of the present disclosure, the table of section 9.2.12.3 of 3GPP TS 38.473 V16.7.0, 2021-10 is modified as shown in FIG. 8.

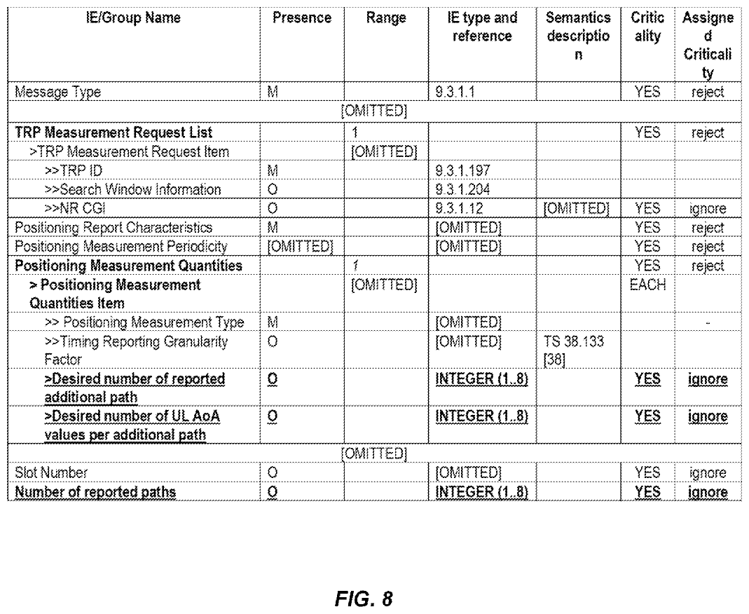

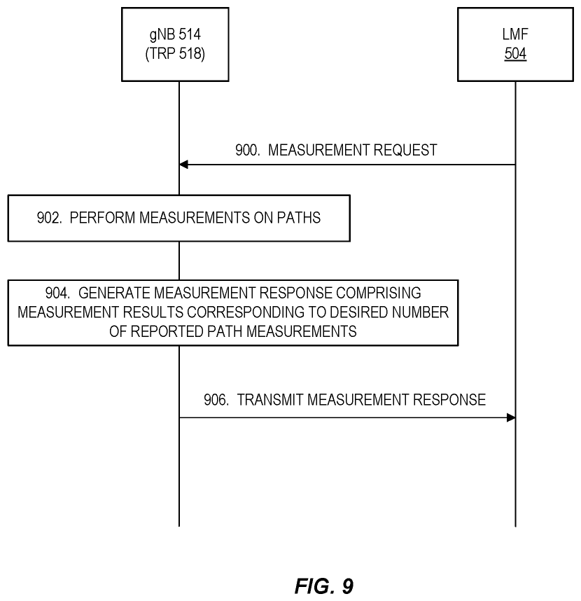

FIG. 9 illustrates the steps performed by the LMF 504 and the gNB 514 in accordance with the above embodiments.

In step 900, the gNB 514 receives a measurement request from the LMF 504. The measurement request may include a desired number of reported path measurements between the gNB 514 and the UE 508.

In step 902, the gNB 514 performs measurements on the paths.

In step 904, the gNB 514 generates a measurement response message comprising measurement results corresponding to the desired number of reported path measurements.

In step 906, the gNB 514 transmits the measurement response message to the LMF 504.

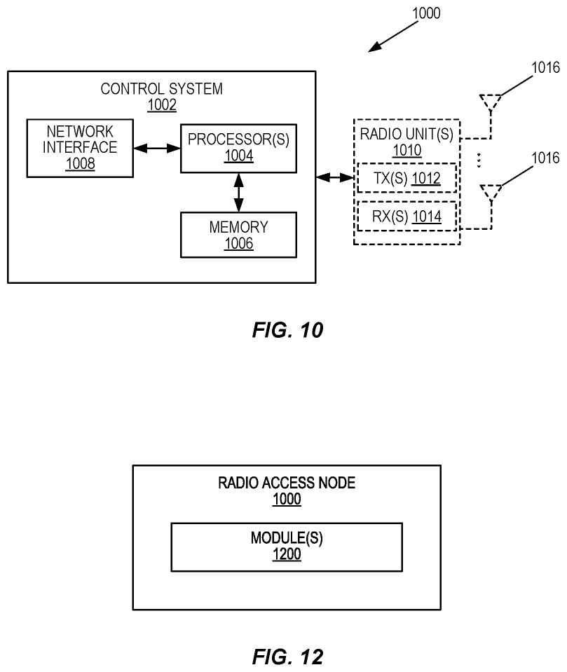

FIG. 10 is a schematic block diagram of a radio access node 1000 according to some embodiments of the present disclosure. Optional features are represented by dashed boxes. The radio access node 1000 may be, for example, a base station such as the gNB 514 or a network node that implements all or part of the functionality of the base station or the gNB 514 described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 (e.g., one or more functions of the gNB 514) as described herein. In some embodiments, the function(s) are implemented in software that is stored, e.g., in the memory 1006 and executed by the one or more processors 1004.

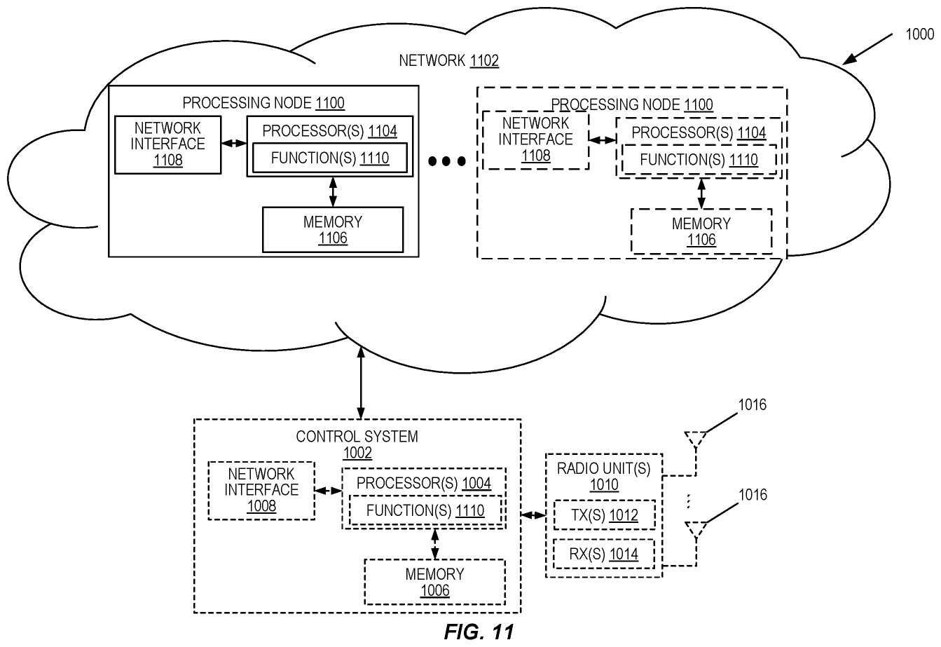

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICS, FPGAS, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

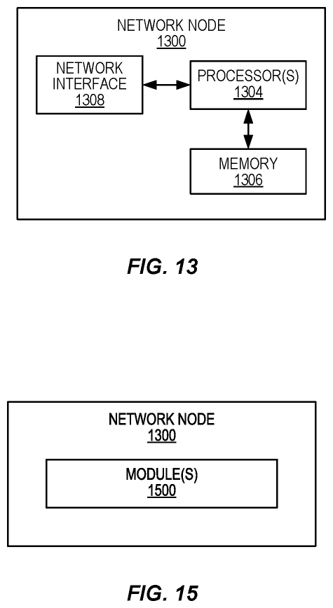

FIG. 13 is a schematic block diagram of a network node 1300 that implements the LMF 504, according to some embodiments of the present disclosure. Optional features are represented by dashed boxes. As illustrated, the network node 1300 includes a one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. The one or more processors 1304 operate to provide one or more functions of the LMF 504 described herein. In some embodiments, the function(s) are implemented in software that is stored, e.g., in the memory 1306 and executed by the one or more processors 1304.

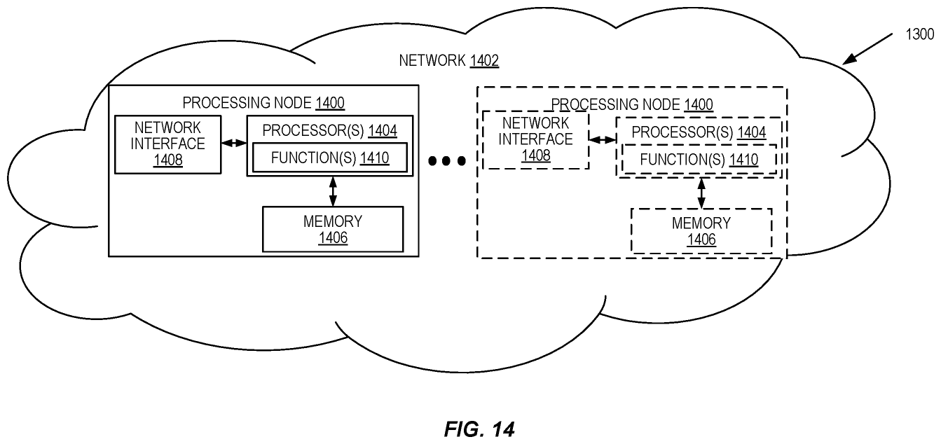

FIG. 14 is a schematic block diagram that illustrates a virtualized embodiment of the network node 1300 according to some embodiments of the present disclosure. Again, optional features are represented by dashed boxes. As used herein, a “virtualized” network node is an implementation of the network node 1300 in which at least a portion of the functionality of the LMF 504 is implemented as a virtual component(s) (e.g., via a virtual machine(s) executing on a physical processing node(s) in a network(s)). As illustrated, in this example, the network node 1300 includes one or more processing nodes 1400 coupled to or included as part of a network(s) 1402. Each processing node 1400 includes one or more processors 1404 (e.g., CPUs, ASICs, FPGAS, and/or the like), memory 1406, and a network interface 1408. In this example, functions 1410 of the LMF 504 described herein are implemented at the one or more processing nodes 1400 or distributed across the two or more processing nodes 1400 in any desired manner. In some particular embodiments, some or all of the functions 1410 of the LMF 504 described herein are implemented as virtual components executed by one or more virtual machines implemented in a virtual environment(s) hosted by the processing node(s) 1400.

In some embodiments, a computer program including instructions which, when executed by at least one processor, causes the at least one processor to carry out the functionality of the LMF 504 or a node (e.g., a processing node 1400) implementing one or more of the functions 1410 of the LMF 504 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the network node 1300 according to some other embodiments of the present disclosure. The network node 1300 includes one or more modules 1500, each of which is implemented in software. The module(s) 1500 provide the functionality of the LMF 504 described herein. This discussion is equally applicable to the processing node 1400 of FIG. 14 where the modules 1500 may be implemented at one of the processing nodes 1400 or distributed across multiple processing nodes 1400.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a base station (514) for exchange of messages related to a location of a User Equipment, UE, (508) with a Location Management Function, LMF, (504) the method comprising:
receiving (900) a measurement request from the LMF (504), the measurement request including a desired number of reported path measurements between the base station (514) and the UE (508);
performing (902) measurements on paths between the base station (514) and the UE (508);
generating (904) a measurement response message comprising measurement results corresponding to the desired number of reported path measurements; and
transmitting (906) the measurement response message to the LMF (504).

Embodiment 2: The method of embodiment 1 wherein the desired number of reported paths with measurements comprises a number of reported paths included in an information element of the measurement request.

Embodiment 3: The method of embodiment 1 or 2 wherein the desired number of reported path measurements is included for a particular measurement type.

Embodiment 4: The method of any of embodiments 1 to 3 wherein the desired number of reported path measurements comprises at least one of (a) a desired number of reported additional path and (b) a desired number of Uplink Angle of Arrival, UL-AoA, values per additional path, which are added to an information element of the measurement request.

Embodiment 5: The method of any of embodiments 1 to 4 wherein the reported path measurements comprise one or more of (a) Uplink Angle of Arrival, UL-AoA, measurements, (b) Uplink Related Time of Arrival, UL-RTOA, measurements, and (c) Reception-Transmission, Rx-Tx, measurements between the base station and the UE.

Embodiment 6: The method of any of embodiments 1 to 5 wherein the base station comprises a distributed unit, gNB-DU, and a central unit, gNB-CU, wherein the measurement request message is transmitted from the LMF 504 to the gNB-CU, and then to the gNB-DU.

Embodiment 7: A method performed by a Location Management Function, LMF, (504) for exchange of messages related to a location of a User Equipment, UE, (508) with a base station (514), the method comprising:
transmitting (900) a measurement request to the base station (514), the measurement request including a desired number of reported path measurements between the base station (514) and the UE (508);
receiving (906) a measurement response message comprising measurement results corresponding to the desired number of reported path measurements from the base station (514).

Embodiment 8: The method of embodiment 7 wherein the desired number of reported paths with measurements comprises a number of reported paths included in an information element of the measurement request.

Embodiment 9: The method of embodiment 7 or 8 wherein the desired number of reported path measurements is included for a particular measurement type.

Embodiment 10: The method of any of embodiments 7 to 9 wherein the desired number of reported path measurements comprises at least one of (a) a desired number of reported additional path and (b) a desired number of Uplink Angle of Arrival, UL-AoA, values per additional path, which are added to an information element of the measurement request.

Embodiment 11: The method of any of embodiments 7 to 10 wherein the reported path measurements comprise one or more of (a) Uplink Angle of Arrival, UL-AoA, measurements, (b) Uplink Related Time of Arrival, UL-RTOA, measurements, and (c) Reception-Transmission, Rx-Tx, measurements between the base station and the UE.

Embodiment 12: The method of any of embodiments 7 to 11 wherein the base station comprises a distributed unit, gNB-DU, and a central unit, gNB-CU, wherein the measurement request message is transmitted from the LMF 504 to the gNB-CU, and then to the gNB-DU.

Embodiment 13: A base station (514) adapted to:
receive (900) a measurement request from a Location Management Function, LMF, (504), the measurement request including a desired number of reported path measurements between a base station (514) and a User Equipment, UE, (508);
perform (902) measurements on paths between the base station (514) and the UE (508);
generate (904) a measurement response message comprising measurement results corresponding to the desired number of reported path measurements; and
transmit (906) the measurement response message to the LMF (504).

Embodiment 14: The base station (514) of embodiment 13 wherein the base station (514) is further adapted to perform the method of any of embodiments 2 to 6.

Embodiment 15: A base station (514) comprising processing circuitry configured to cause the base station (514) to:
receive (900) a measurement request from a Location Management Function, LMF, (504), the measurement request including a desired number of reported path measurements between a base station (514) and a User Equipment, UE, (508);
perform (902) measurements on paths between the base station (514) and the UE (508);
generate (904) a measurement response message comprising measurement results corresponding to the desired number of reported path measurements; and
transmit (906) the measurement response message to the LMF (504).

Embodiment 16: The base station (514) of embodiment 15 wherein the processing circuitry is further configured to cause the base station (514) to perform the method of any of embodiments 2 to 6.

Embodiment 17: A Location Management Function, LMF, (504) adapted to:
transmit (900) a measurement request to a base station (514), the measurement request including a desired number of reported path measurements between the base station (514) and a User Equipment, UE, (508);
receive (906) a measurement response message comprising measurement results corresponding to the desired number of reported path measurements from the base station (514).

Embodiment 18: The LMF (504) of embodiment 17 wherein the LMF (504) is further adapted to perform the method of any of embodiments 8 to 12.

Embodiment 19: A Location Management Function, LMF, (504) comprising processing circuitry configured to cause the LMF (504) to:
transmit (900) a measurement request to a base station (514), the measurement request including a desired number of reported path measurements between the base station (514) and a User Equipment, UE, (508);
receive (906) a measurement response message comprising measurement results corresponding to the desired number of reported path measurements from the base station (514).

Embodiment 20: The LMF (504) of embodiment 19 wherein the processing circuitry is further configured to cause the LMF (504) to perform the method of any of embodiments 8 to 12.

Those skilled in the art will recognize improvements and modifications to the embodiments of the present disclosure. All such improvements and modifications are considered within the scope of the concepts disclosed herein.

1. A method performed by a base station for exchange of messages related to a location of a User Equipment, UE, with a Location Management Function, LMF, the method comprising:
receiving a measurement request from the LMF, the measurement request comprising information that indicates whether additional path measurements between the base station and the UE are to be reported and whether multiple uplink, UL, Angle of Arrival, AoA, measurements are to be reported for each additional path;
performing measurements on paths between the base station and the UE;
generating a measurement response message comprising results of the measurements for the additional path measurements; and
transmitting the measurement response message to the LMF.

2. The method of claim 1 wherein the information that indicates the additional path measurements is comprised in an information element within the measurement request.

3. The method of claim 1 wherein the additional path measurements is indicated for a particular measurement type.

4. The method of claim 1 wherein the additional path measurements comprises at least one of (a) a desired number of reported additional paths and (b) a desired number of UL-AoA values per additional path.

5. The method of claim 1 wherein the measurements comprise one or more of (a) UL-AoA measurements, (b) Uplink Related Time of Arrival, UL-RTOA, measurements, and (c) Reception-Transmission, Rx-Tx, measurements between the base station and the UE.

6. The method of claim 1 wherein the base station comprises a distributed unit, gNB-DU, and a central unit, gNB-CU, wherein receiving the measurement request message comprises receiving the measurement request message from the LMF at the gNB-CU, wherein the gN-CU sends the measurement request message to the gNB-DU.

7. (canceled)

8. (canceled)

9. A base station comprising processing circuitry configured to cause the base station to:
receive a measurement request from a Location Management Function, LMF, the measurement request comprising information that indicates whether additional path measurements between a base station and a User Equipment, UE, are to be reported and whether multiple uplink, UL, Angle of Arrival, AoA, measurements are to be reported for each additional path;
perform measurements on paths between the base station and the UE;
generate a measurement response message comprising results of the measurements for the additional path measurements; and
transmit the measurement response message to the LMF.

10. (canceled)

11. A method performed by a Location Management Function, LMF, for exchange of messages related to a location of a User Equipment, UE, with a base station, the method comprising:
transmitting a measurement request to the base station, the measurement request comprising information that indicates whether additional path measurements between the base station and the UE are to be reported and whether multiple uplink, UL, Angle of Arrival, AoA, measurements are to be reported for each additional path; and
receiving a measurement response message comprising measurement results for the additional path measurements from the base station.

12. The method of claim 11 wherein the information that indicates the additional path measurements is comprised in an information element within the measurement request.

13. The method of claim 11 wherein the additional path measurements is indicated for a particular measurement type.

14. The method of claim 11 wherein the additional path measurements comprises at least one of (a) a desired number of reported additional paths and (b) a desired number of UL-AoA values per additional path.

15. The method of claim 11 wherein the reported path measurements comprise one or more of (a) UL-AoA measurements, (b) Uplink Related Time of Arrival, UL-RTOA, measurements, and (c) Reception-Transmission, Rx-Tx, measurements between the base station and the UE.

16. The method of claim 11 wherein the base station comprises a distributed unit, gNB-DU, and a central unit, gNB-CU, wherein transmitting the measurement request message comprises transmitting the measurement request message from the LMF to the gNB-CU.

17. (canceled)

18. (canceled)

19. A network node that implements a Location Management Function, LMF, the network node comprising processing circuitry configured to cause the network node to:
transmit a measurement request to a base station, the measurement request comprising information that indicates whether additional path measurements between the base station and a User Equipment, UE, are to be reported and whether multiple uplink, UL, Angle of Arrival, AoA, measurements are to be reported for each additional path; and
receive a measurement response message comprising measurement results for the additional path measurements from the base station.

20. (canceled)
